(19) United States
(12) Patent Application Publication
(10) Pub. No.: US 2025/0340799 A1
(43) Pub. Date: Nov. 6, 2025

(54) LIQUID DETERGENT COMPOSITION

(71) Applicant: KAO CORPORATION, Tokyo (JP)

(72) Inventors: Kan JI, Wakayama -shi, Wakayama (JP); Seiji YANO, Wakayama -shi, Wakayama (JP); Hidekazu IMANAKA, Wakayama -shi, Wakayama (JP)

(73) Assignee: KAO CORPORATION, Tokyo (JP)

(21) Appl. No.: 18/855,424

(22) PCT Filed: Apr. 11, 2023
(86) PCT No.: PCT/JP2023/014695

§ 371 Date: Oct. 9, 2024

(30) Foreign Application Priority Data
Apr. 13, 2022 (JP) 2022-066043

(51) Int. Cl. C11D 1/65; C11D 1/10; C11D 1/14; C11D 1/42

(52) U.S. Cl. CPC C11D 1/65; C11D 1/10; C11D 1/143; C11D 1/42

(57) ABSTRACT

Provided are a liquid detergent composition and a method for washing textile products using the liquid detergent composition that provides excellent washing performance to sebum stains and anti-wrinkle performance for textile products even when water having high hardness is used. The liquid detergent composition contains an anionic surfactant containing an internal olefin sulfonate with 16 or more and 24 or less carbons; an amine-based alkali agent; a carbonate-based alkali agent; and water. The mass content of the internal olefin sulfonate in the anionic surfactant is 70% or more and 100% or less. The liquid detergent composition has a pH of 8.5 or more and 11.0 or less at 20° C.

### FIELD OF THE INVENTION

The present invention relates to a liquid detergent composition and a method for washing textile products.

### BACKGROUND OF THE INVENTION

In recent years, performances of liquid detergent compositions for textile products demanded by consumers have been diversified, and not only performance in washing but also avoidance of deteriorated performance in finishing (softening performance and anti-wrinkle performance for textile products) have been required.

Anionic surfactants, in particular, alkylbenzene sulfonates and olefin sulfonates, moreover, internal olefin sulfonates obtained from internal olefins having a double bond not at an end of the olefin chain but in the inside as a raw material, and nonionic surfactants containing an oxyalkylene group with two to three carbons are conventionally used widely as washing components for home use and industrial use.

WO-A 2017/209117 discloses a detergent composition for fibers, the composition containing component (A), component (B) and component (C) shown below, wherein a mass ratio of component (B) to component (A), (B)/(A), is 0 or more and 1.0 or less, the composition contains a nonionic surfactant having an HLB of more than 10.5 if the composition contains component (B), a content of component (C) is 20 mass % or less, and the composition is a composition for use in washing fibers in water containing a hardness component:
component (A): an internal olefin sulfonate with 17 or more and 24 or less carbons;
component (B): a nonionic surfactant; and component (C): a metal ion chelating agent.

JP-A 2021-134324 discloses a liquid detergent article for textile products obtained by storing a liquid detergent composition for textile products in a bag-like container, the liquid detergent composition containing: (A) 1 mass % or more and 50 mass % or less of an internal olefin sulfonate [hereinafter referred to as component (A)]; (B) 0.01 mass or more and 10 masse or less of an alkanolamine [hereinafter referred to as component (B)]; (C) 0.1 mass % or more and 40 mass % or less of an organic solvent having a hydroxyl group [hereinafter referred to as component (C)]; and water, wherein the composition has a proportion of an internal olefin sulfonate with 18 carbons [hereinafter referred to as component (A1)] in component (A) of 80 mass % or more, and a pH of 6.0 or more and 11.0 or less at 20° C.

### SUMMARY OF THE INVENTION

While detergent compositions with an internal olefin sulfonate having a hydrocarbon group with a specific number of carbons as a surfactant are known to be excellent not only in performance in washing for textile products but also in performance in finishing (softening performance and anti-wrinkle performance for textile products), the present inventors have found that if such detergent compositions with an internal olefin sulfonate are used for washing textile products with water having high hardness, performance in washing and that in finishing are not achieved in combination in a manner satisfactory to consumers.

The present invention provides a liquid detergent composition that exhibits good liquid color stability at high temperature and low-temperature storage stability and provides excellent washing performance to sebum stains and anti-wrinkle performance for textile products even when water having high hardness is used, and a method for washing textile products that provides excellent washing performance to sebum stains and anti-wrinkle performance for textile products even when water having high hardness is used.

The present invention relates to a liquid detergent composition containing: (a) an anionic surfactant (hereinafter referred to as component (a)) containing an internal olefin sulfonate with 16 or more and 24 or less carbons (hereinafter referred to as component (a1)); (b1) an amine-based alkali agent (hereinafter referred to as component (b1)); (b2) a carbonate-based alkali agent (hereinafter referred to as component (b2)); and water, wherein the liquid detergent composition has a content of component (a1) in component (a) of 70 mass % or more and 100 mass % or less, and has a pH of 8.5 or more and 11.0 or less at 20° C.

Further, the present invention relates to a method for washing textile products, including washing textile products with a washing liquid containing: (a) an anionic surfactant (hereinafter referred to as component (a)) containing an internal olefin sulfonate with 16 or more and 24 or less carbons (hereinafter referred to as component (a1)); (b1) an amine-based alkali agent (hereinafter referred to as component (b1)); (b2) a carbonate-based alkali agent (hereinafter referred to as component (b2)); and water, wherein the washing liquid has a content of component (a1) in component (a) of 70 mass % or more and 100 mass % or less, and a pH of 7.5 or more and 10.5 or less.

The present invention provides a liquid detergent composition that exhibits good liquid color stability at high temperature and low-temperature storage stability and provides excellent washing performance to sebum stains and anti-wrinkle performance for textile products even when water having high hardness is used, and a method for washing textile products that provides excellent washing performance to sebum stains and anti-wrinkle performance for textile products even when water having high hardness is used.

### EMBODIMENTS OF THE INVENTION

### [Liquid Detergent Composition]

While the reason why the liquid detergent composition of the present invention exhibits good liquid color stability at high temperature and low-temperature storage stability and provides excellent washing performance to sebum stains and anti-wrinkle performance for textile products is not completely elucidated, the following is inferred.

Component (a1) forms micelles and vesicles in a washing liquid, and the micelles act on sebum stains adhering to a textile product and the vesicles modify the surface of the textile product; as a result, washing performance to sebum stains and finishing performance are successfully achieved in combination.

However, if water having high hardness is used for the washing liquid, component (a1) bonds to a large amount of calcium contained in the water to form a large number of vesicles, which leads to reduced formation of micelles and results in insufficient washing performance to sebum stains.

In such circumstances, the present inventors have found the liquid detergent composition of the present invention, for which component (a1) is used in combination with specific alkali agents of component (b1) and component (b2) at a specific mass ratio.

When water having high hardness is used for a washing liquid, most of component (a1) forms vesicles, resulting in deteriorated washing performance to sebum stains. Further, if other surfactants effective for washing performance to sebum stains are used in combination with component (a1), better washing performance to sebum stains is obtained but the vesicle formation of component (a1) is largely interfered, and thus washing performance to sebum stains and anti-wrinkle performance cannot be achieved in combination. The reason why washing performance to sebum stains and finishing performance are successfully achieved in combination in the liquid detergent composition of the present invention, for which component (a1), component (b1) and component (b2) are used, is inferred to be that the specific alkali agents of component (b1) and component (b2) do not affect the vesicle formation of component (a1), thus allowing surface modification of textile products, and further, the specific alkali agents of component (b1) and component (b2) act on sebum stains to neutralize fatty acids in the sebum stains, and this functions as a surfactant to allow the sebum stains to be washed off.

Further, the reason why good liquid color stability at high temperature and good low-temperature storage stability are both successfully achieved in the liquid detergent composition of the present invention is inferred to be that the alkali agent of component (b1) and the alkali agent of component (b2) are used at a specific mass ratio in combination.

<Component (a)>

Component (a) of the present invention is an anionic surfactant containing an internal olefin sulfonate with 16 or more and 24 or less carbons (component (a1)).

The carbon number of the internal olefin sulfonate with 16 or more and 24 or less carbons represents the carbon number of an internal olefin to which a sulfonate is covalently bonded. The internal olefin sulfonate with 16 or more and 24 or less carbons has 17 or more and preferably 18 or more carbons from the viewpoint of anti-wrinkle performance for fibers, and 24 or less, preferably 22 or less and more preferably 20 or less carbons from the viewpoint of washing performance to sebum stains.

The internal olefin sulfonate of the present invention is a sulfonate obtained by sulfonating, neutralizing and hydrolyzing an internal olefin (an olefin having a double bond inside the olefin chain) with 16 or more and 24 or less carbons as a raw material.

The internal olefin also contains a minute amount of a so-called alfa-olefin (hereinafter also referred to as an α-olefin), which has a double bond at position 1 of the carbon chain. Further, a β-sultone is quantitatively produced through the sulfonation of the internal olefin, part of the β-sultone is changed into a γ-sultone and an olefin sulfonic acid, and these are further converted into a hydroxy alkane sulfonate and an olefin sulfonate in the neutralizing and hydrolyzing processes (for example, J. Am. Oil Chem. Soc. 69, 39 (1992)). Here, a hydroxy alkane sulfonate and an olefin sulfonate to be obtained respectively have a hydroxy group inside the alkane chain and a double bond inside the olefin chain. Further, a product to be obtained is mainly a mixture of these, and may sometimes also partially contain a minute amount of a hydroxy alkane sulfonate having a hydroxy group at the end of the carbon chain or an olefin sulfonate having a double bond at the end of the carbon chain.

In the present specification, each of these products and a mixture of them are collectively referred to as the internal olefin sulfonate (component (a1)). Further, the hydroxy alkane sulfonates are referred to as hydroxy species of the internal olefin sulfonate (hereinafter also referred to as HAS), and the olefin sulfonates are referred to as olefin species of the internal olefin sulfonate (hereinafter also referred to as IOS).

Note that a mass ratio between the compounds of HAS and IOS in component (a1) can be measured by a high-performance liquid chromatography mass spectrometer (hereinafter abbreviated as HPLC-MS). Specifically, the mass ratio can be determined from the HPLC-MS peak areas of component (a1).

Examples of a salt of the internal olefin sulfonate include an alkali metal salt, an alkaline earth metal (1/2 atom) salt, and an ammonium salt or an organic ammonium salt. Examples of the alkali metal salt include a sodium salt and a potassium salt. Examples of the organic ammonium salt include an alkanol ammonium salt with 2 or more and 6 or less carbons. The salt of the internal olefin sulfonate is preferably an alkali metal salt, and more preferably one or more selected from a sodium salt and a potassium salt from the viewpoint of versatility.

As is clear from the above producing method, the internal olefin sulfonate of component (a1) has a sulfonic acid group inside the carbon chain of the internal olefin sulfonate, which is, namely, an olefin chain or an alkane chain, and may sometimes also partially contain a minute amount of a compound having a sulfonic acid group at the end of the carbon chain.

A content of an internal olefin sulfonate with a sulfonic acid group present at position 5 or more and preferably position 5 or more and 9 or less in component (a1) is preferably 5 mass % or more, more preferably 10 mass % or more, further preferably 15 mass % or more, furthermore preferably 20 mass or more, furthermore preferably 30 mass % or more and furthermore preferably 35 mass % or more, and preferably 60 mass % or less, more preferably 50 mass % or less and further preferably 40 mass % or less from the viewpoint of anti-wrinkle performance for fibers.

A mass ratio of a content of an internal olefin sulfonate with a sulfonic acid group present at position 2 or more and 4 or less [hereinafter sometimes referred to as (IO-1S)] to a content of an internal olefin sulfonate with a sulfonic acid group present at position 5 or more and preferably position 5 or more and 9 or less [hereinafter sometimes referred to as (IO-2S)] in component (a1), (IO-1S)/(IO-2S), is preferably 0.5 or more, more preferably 0.7 or more, further preferably 1.0 or more and furthermore preferably 1.4 or more, and preferably 10 or less, more preferably 6 or less, further preferably 5 or less, furthermore preferably 3 or less, furthermore preferably 2 or less and furthermore preferably 1.8 or less from the viewpoint of anti-wrinkle performance for fibers.

Note that the contents of the compounds having a sulfonic acid group at different positions in component (a1) can be measured by HPLC-MS. The contents of the compounds having a sulfonic acid group at different positions in the present specification are determined as mass ratios based on the HPLC-MS peak areas of the compounds having a sulfonic acid group at their respective positions in the total of HAS species of component (a1).

In component (a1), a content of an olefin sulfonate with a sulfonic acid group present at position 1 is preferably 10 mass % or less, more preferably 7 mass % or less, further preferably 5 mass % or less, furthermore preferably 3 mass % or less and furthermore preferably 2 mass % or less from the viewpoint of capability of imparting good anti-wrinkle performance to fibers even when the temperature of water used for washing is as low as 0° C. or more and 15° C. or less, and preferably 0.01 mass % or more from the viewpoints of reduction of production costs and improvement of productivity.

The positions of a sulfonic acid group in these compounds are positions in the olefin chains or the alkane chains.

The internal olefin sulfonate can be a mixture of hydroxy species and olefin species. A mass ratio of a content of olefin species of the internal olefin sulfonate to a content of hydroxy species of the internal olefin sulfonate in component (a1) (olefin species/hydroxy species) can be 0/100 or more, further 5/95 or more and further 10/90 or more, and 50/50 or less, further 40/60 or less, further 30/70 or less, further 25/75 or less and further 20/80 or less.

The mass ratio of a content of olefin species of the internal olefin sulfonate to a content of hydroxy species of the internal olefin sulfonate in component (a1) can be measured by HPLC-MS with a method described in Examples.

Component (a1) can be produced by sulfonating, neutralizing and hydrolyzing an internal olefin with 16 or more and 24 or less carbons as a raw material. The sulfonation reaction can be carried out by reacting 1.0 to 1.2 mol of sulfur trioxide gas with 1 mol of the internal olefin. It can be carried out at a reaction temperature of 20 to 40° C.

The neutralization is carried out by reacting an aqueous alkali solution such as sodium hydroxide, ammonia, 2-aminoethanol or the like in an amount 1.0 to 1.5 molar times the theoretic value for a sulfonic acid group. The hydrolysis reaction may be carried out at 90 to 200° C. for 30 minutes to 3 hours in the presence of water. These reactions can be carried out in succession. Further, after the reactions are completed, purification can be carried out by extraction, washing or the like.

Note that in producing the internal olefin sulfonate (a1), sulfonation, neutralization, and hydrolysis treatments may be carried out using raw material internal olefins with a distribution of carbon numbers of 16 or more and 24 or less, and sulfonation, neutralization, and hydrolysis treatments may be carried out using raw material internal olefins with a single carbon number, or a plurality of internal olefin sulfonates with different carbon numbers that have been produced in advance may be mixed together, as necessary.

In the present invention, the internal olefin refers to an olefin having a double bond inside the olefin chain, as described above. The internal olefin as a raw material of component (a1) has 16 or more and 24 or less carbons. A single internal olefin or a combination of two or more internal olefins may be used as a raw material of component (a1).

Examples of anionic surfactants as component (a) other than component (a1) include, for example, one or more selected from an alkylbenzene sulfonate, an alkyl or alkenyl ether sulfate, an alkyl or alkenyl sulfate, an olefin sulfonate other than component (a1), an alkane sulfonate, a saturated or unsaturated fatty acid salt, an alkyl or alkenyl ether carboxylate, an α-sulfofatty acid salt, an N-acylamino acid, a phosphoric acid mono- or diester and a sulfosuccinic acid ester. Examples of the alkyl ether sulfate include a polyoxyethylene alkyl ether sulfate.

The alkyl group or alkenyl group of the anionic surfactants has, for example, 8 or more and 22 or less carbons. The average number of added moles of oxyethylene groups of the anionic surfactants is, for example, 0 or more and 10 or less.

Examples of counterions to the anionic groups in these anionic surfactants include: an alkali metal ion such as a sodium ion, a potassium ion or the like; an alkaline earth metal ion such as a calcium ion, a magnesium ion or the like; an ammonium ion; and an alkanolamine having 1 to 3 alkanol groups with 2 or 3 carbons (for example, monoethanolamine, diethanolamine, triethanolamine, triisopropanolamine or the like).

One of these anionic surfactants alone or a combination of two or more thereof can be used.

<Component (b1)>

Component (b1) is an amine-based alkali agent.

Examples of the amine-based alkali agent as component (b1) include, for example, one or more selected from alkanolamines and amino acids.

Examples of the alkanolamine include an amine compound, wherein the compound is a primary or higher and tertiary or lower monoamine compound and has 1 or more and 3 or less hydroxyalkyl groups with 2 or more and 4 or less carbons bonding to a nitrogen atom. If the alkanolamine has a group other than the hydroxyalkyl group, examples of such a group include an organic group, for example, an alkyl group with 1 or more and 4 or less carbons and preferably a methyl group.

Specific examples of the alkanolamine can include one or more selected from monoethanolamine, diethanolamine, triethanolamine, monopropanolamine, dipropanolamine, tripropanolamine, tris(hydroxymethyl)aminomethane, N-methylethanolamine, N-methylpropanolamine and N-ethylethanolamine.

Examples of the amino acid include one or more selected from a neutral amino acid and a basic amino acid.

Examples of the neutral amino acid include glycine, sarcosine, L-serine, β-alanine, aminobutyric acid or the like.

Examples of the basic amino acid include arginine, lysine or the like.

Component (b1) is preferably one or more selected from monoethanolamine, diethanolamine, triethanolamine, glycine, arginine and tris(hydroxymethyl)aminomethane, more preferably one or more selected from monoethanolamine, diethanolamine, triethanolamine and glycine, further preferably one or more selected from monoethanolamine and glycine and furthermore preferably monoethanolamine from the viewpoints of washing performance to sebum stains and low-temperature stability.

Component (b1) may be combined as a counterion to component (a), for example, to the internal olefin sulfonate of component (a1) in the composition. Further, depending on the pH of the composition, component (b1) may be present as an ammonium ion in the composition. In the present invention, such a compound in the form of an ammonium ion is also regarded as component (b1).

<Component (b2)>

Component (b2) of the present invention is a carbonate-based alkali agent.

Examples of the carbonate-based alkali agent as component (b2) include one or more selected from sodium carbonate, potassium carbonate, sodium sesquicarbonate, potassium sesquicarbonate, sodium hydrogen carbonate and potassium hydrogen carbonate, and the carbonate-based alkali agent is preferably one or more selected from sodium carbonate, potassium carbonate, sodium hydrogen carbonate and potassium hydrogen carbonate from the viewpoint of production costs, and more preferably one or more selected from potassium carbonate and potassium hydrogen carbonate from the viewpoints of liquid color stability at high temperature and solubility.

### Composition and Others

The liquid detergent composition of the present invention contains component (a) in an amount of preferably 5 mass % or more, more preferably 8 mass % or more and further preferably 12 masse or more from the viewpoints of anti-wrinkle performance for fibers and washing performance to sebum stains, and preferably 50 mass % or less, more preferably 40 mass % or less, further preferably 30 mass % or less, furthermore preferably 20 mass % or less and furthermore preferably 18 mass or less from the viewpoint of liquid color stability at high temperature.

Note that, for specification of the mass of component (a) (including component (a1)) in the liquid detergent composition of the present invention, values expressed in terms of a sodium salt are used.

From the viewpoint of anti-wrinkle performance for fibers, a content of component (a1) in component (a) in the liquid detergent composition of the present invention is 70 mass % or more, preferably 80 masse or more and more preferably 90 mass % or more, and 100 mass % or less, and may be 100 mass %.

The liquid detergent composition of the present invention contains component (a1) in an amount of preferably 5 mass % or more, more preferably 8 mass % or more and further preferably 12 mass % or more, and preferably 50 mass % or less, more preferably 40 masse or less, further preferably 30 mass % or less, furthermore preferably 20 mass % or less and furthermore preferably 18 mass % or less from the viewpoints of anti-wrinkle performance for fibers and stability of products.

The liquid detergent composition of the present invention contains component (b1) in an amount of preferably 0.5 mass % or more, more preferably 0.65 mass % or more and further preferably 0.8 mass % or more from the viewpoints of low-temperature stability and washing performance to sebum stains, and preferably 2.8 mass % or less, more preferably 2.5 mass % or less, further preferably 1.9 mass % or less and furthermore preferably 1.5 mass % or less from the viewpoint of liquid color stability at high temperature.

The liquid detergent composition of the present invention contains component (b2) in an amount of preferably 0.3 mass % or more, more preferably 0.5 mass % or more and further preferably 1.1 mass % or more from the viewpoints of washing performance to sebum stains and liquid color stability at high temperature, and preferably 4.2 mass % or less, more preferably 3.4 mass % or less, further preferably 2.5 mass % or less and furthermore preferably 2 mass % or less from the viewpoint of low-temperature stability.

A mass ratio of a content of component (b2) to a total content of component (b1) and component (b2), (b2)/[(b1)+(b2)], in the liquid detergent composition of the present invention is preferably 0.1 or more, more preferably 0.17 or more, further preferably 0.37 or more and furthermore preferably 0.4 or more from the viewpoints of washing performance to sebum stains and liquid color stability at high temperature, and preferably 0.83 or less, more preferably 0.75 or less and further preferably 0.65 or less from the viewpoints of washing performance to sebum stains and low-temperature stability.

A mass ratio of a total content of component (b1) and component (b2) to a content of component (a), [(b1)+(b2)]/(a), in the liquid detergent composition of the present invention is preferably 0.13 or more, more preferably 0.15 or more and further preferably 0.18 or more from the viewpoint of washing performance to sebum stains, and preferably 0.65 or less, more preferably 0.5 or less and further preferably 0.35 or less from the viewpoints of washing performance to sebum stains, liquid color stability at high temperature, anti-wrinkle performance for fibers and low-temperature stability.

A mass ratio of a total content of component (b1) and component (b2) to a content of component (a1), [(b1)+(b2)]/(a1), in the liquid detergent composition of the present invention is preferably 0.13 or more, more preferably 0.15 or more and further preferably 0.18 or more from the viewpoint of washing performance to sebum stains, and preferably 0.65 or less, more preferably 0.5 or less and further preferably 0.35 or less from the viewpoints of washing performance to sebum stains, liquid color stability at high temperature, anti-wrinkle performance for fibers and low-temperature stability.

The liquid detergent composition of the present invention can contain a polyalkylene glycol having a weight-average molecular weight of 100 or more and 100000 or less as component (c) from the viewpoints of low-temperature stability and viscosity adjustment.

Examples of component (c) include one or more selected from polyethylene glycol and polypropylene glycol.

The weight-average molecular weight of component (c) is 100 or more and preferably 500 or more, and 10000 or less, preferably 2000 or less and more preferably 1500 or less.

Here, the weight-average molecular weight is a value determined through gel permeation chromatography with polystyrene as a reference substance.

The liquid detergent composition of the present invention contains component (c) in an amount of preferably 0.05 mass % or more, more preferably 0.1 mass % or more and further preferably 0.15 mass % or more, and preferably 10 mass % or less, more preferably 5 mass % or less, further preferably 1 mass % or less and furthermore preferably 0.5 mass % or less from the viewpoints of low-temperature stability, viscosity adjustment and not preventing anti-wrinkle performance for fibers.

The liquid detergent composition of the present invention can contain a fragrance composition as component (d). The liquid detergent composition of the present invention preferably contains a fragrance composition whose formulation is composed of various types of fragrance compounds used for detergent products for textile products. Examples of the fragrance compounds constituting the fragrance composition include, for example, fragrance compounds described in JP-A 2017-214676. A fragrance composition in the form of being included in microcapsule particles or in the form of an external fragrance (non-microcapsule) may be formulated in the liquid detergent composition. Microcapsules are obtained by encapsulating a fragrance composition as a functional component. The fragrance composition is enclosed according to a known method, for example, with use of a resin for the outer shell (wall material) of the microcapsules.

The liquid detergent composition of the present invention contains water. For the water, deionized water (sometimes referred to as ion exchange water) or water obtained by adding 1 mg/kg or more and 5 mg/kg or less of sodium hypochlorite to ion exchange water can be used. Alternatively, tap water can be used.

The liquid detergent composition of the present invention contains water in an amount of preferably 50 mass % or more, more preferably 60 mass % or more and further preferably 70 mass % or more, and preferably 95 mass % or less, more preferably 90 mass % or less and further preferably 85 mass % or less.

The liquid detergent composition of the present invention can contain a component that is added to common compositions used for treatment of textile products, and can contain, for example, an organic solvent, a pH adjuster, a preservative, a pigment, a chelating agent, a hydrotropic agent or the like (with the proviso that components corresponding to any of component (a), component (b1), component (b2), component (c) and component (d) are excluded).

The pH of the liquid detergent composition of the present invention at 20° C. is 8.5 or more, preferably 8.7 or more and more preferably 9.0 or more, and 11.0 or less, preferably 10.5 or less and more preferably 10.0 or less from the viewpoints of washing performance to sebum stains and liquid color stability at high temperature. The pH is measured according to a pH measurement method described below. For adjusting the pH to such a value, a common acid such as sulfuric acid, hydrochloric acid, phosphoric acid, acetic acid, lactic acid or the like and an alkali agent such as sodium hydroxide, potassium hydroxide, component (b1), component (b2) or the like can be used.

### <pH Measurement Method>

A composite electrode for pH measurements (manufactured by HORIBA, Ltd., glass slide-in sleeve type) is connected to a pH meter (manufactured by HORIBA, Ltd., pH/ion meter F-23), and the power is turned on. A saturated potassium chloride aqueous solution (3.33 mol/L) is used as the internal solution for the pH electrode. Next, a pH 4.01 standard solution (phthalate standard solution), a pH 6.86 standard solution (neutral phosphate standard solution) and a pH 9.18 standard solution (borate standard solution) are each placed in a 100-mL beaker, and immersed in a constant temperature bath at 20° C. for 30 minutes. The electrode for pH measurements is immersed in the standard solutions at an adjusted constant temperature for 3 minutes to perform a calibration operation in the order of pH 6.86, pH 9.18 and pH 4.01. The temperature of a sample to be measured is adjusted to 20° C., the electrode of the pH meter is immersed in the sample, and the pH 1 minute later is measured.

The viscosity of the liquid detergent composition of the present invention at 20° C. is preferably 10 mPa·s or more, more preferably 30 mPa·s or more and further preferably 50 mPa·s or more, and preferably 400 mPa·s or less, more preferably 300 mPa·s or less and further preferably 200 mPa·s or less from the viewpoint of easiness in handling. Note that the viscosity is one measured by using a B-type viscometer (manufactured by TOKYO KEIKI INC., VISCOMETER MODEL DVM-B) with a rotor No. 3 or 4 at a rotational frequency of 60 r/min for a measurement time of 60 seconds. A rotor suitable for the viscosity of a sample is selected; however, if viscosity regions that can be measured overlap with each other and different numerical values are obtained, a numerical value measured with a rotor No. 3 is employed.

The liquid detergent composition of the present invention can be preferably used for washing textile products.

The fibers to be washed with the liquid detergent composition of the present invention may be either hydrophobic fibers or hydrophilic fibers. Examples of the hydrophobic fibers include, for example, protein fibers (milk protein casein fiber, promix or the like), polyamide fibers (nylon or the like), polyester fibers (polyester or the like), polyacrylonitrile fibers (acrylic or the like), polyvinyl alcohol fibers (vinylon or the like), polyvinyl chloride fibers (polyvinyl chloride or the like), polyvinylidene chloride fibers (vinylidene or the like), polyolefin fibers (polyethylene, polypropylene or the like), polyurethane fibers (polyurethane or the like), polyvinyl chloride/polyvinyl alcohol copolymer fibers (polyclar or the like), polyalkylene paraoxybenzoate fibers (benzoate or the like), polyfluoroethylene fibers (polytetrafluoroethylene or the like), glass fibers, carbon fibers, alumina fibers, silicon carbide fibers, rock fibers, slag fibers, metal fibers (gold threads, silver threads, steel fibers) and others. Examples of the hydrophilic fibers include, for example, seed hair fibers (cotton, kapok or the like), bast fibers (hemp, flax, ramie, cannabis, jute or the like), vein fibers (manila hemp, sisal hemp or the like), palm fibers, juncus, straw, animal hair fibers (wool, mohair, cashmere, camel hair, alpaca, vicuna, angora or the like), silk fibers (domestic silk, wild silk), feathers, cellulose fibers (rayon, polynosic, cupro, acetate or the like) and others.

The fibers are preferably fibers including cotton fiber from the viewpoint of readily appreciable finishing performance for fibers after being washed with the liquid detergent composition of the present invention. From the viewpoint of finishing performance for fibers, a content of cotton fiber in the fibers is preferably 5 mass or more, more preferably 10 mass % or more, further preferably 15 mass % or more, furthermore preferably 20 mass % or more, furthermore preferably 40 mass % or more, furthermore preferably 60 mass or more and furthermore preferably 80 mass % or more, and preferably 100 mass % or less, and may be 100 mass %.

In the present invention, a textile product means fabrics such as woven fabrics, knitted fabrics, nonwoven fabrics or the like using any of the above hydrophobic fibers or hydrophilic fibers, and products obtained by using them, such as undershirts, T-shirts, dress shirts, blouses, slacks, caps, handkerchiefs, towels, knitwear, socks, underwear, tights or the like.

The liquid detergent composition of the present invention is suitable for washing textile products in water containing a hardness component. The phrase “suitable for washing textile products in water containing a hardness component” means that even when a textile product is washed with the liquid detergent composition of the present invention in water containing a hardness component, the textile product can be finished to have clean appearance with reduced wrinkles, and sebum stains adhering to the textile product can be washed off.

The hardness of the water containing a hardness component for use in washing is preferably 8° dH or more, more preferably 8.5° dH or more and further preferably 9° dH or more, and preferably 20° dH or less, more preferably 17°dH or less, further preferably 15° dH or less in German hardness from the viewpoints of washing performance to sebum stains and anti-wrinkle performance for fibers.

German hardness (° dH) in the present specification refers to a value calculated from calcium and magnesium concentrations in water expressed in terms of CaCO₃ with the relationship 1 mg/L (ppm)=approximately 0.056° dH (1° dH=17.8 ppm).

The calcium and magnesium concentrations for German hardness are determined with chelate titration using ethylenediaminetetraacetate disodium salt.

A specific method for measuring the German hardness of water in the present specification is as follows.

### <Method for Measuring German Hardness of Water>

### [Reagent]

0.01 mol/l EDTA·2Na solution: a 0.01 mol/l aqueous solution of disodium ethylenediaminetetraacetate (a solution for titration, 0.01 M EDTA-2Na, manufactured by Sigma-Aldrich Co. LLC)
Indicator Universal BT (product name: Universal BT, manufactured by DOJINDO LABORATORIES)
Ammonia buffer solution for hardness measurements (a solution obtained by dissolving 67.5 g of ammonium chloride in 570 ml of 28 w/v % ammonia water and making the total amount 1000 ml with ion exchange water)

### [Measurement of Hardness]

(1) 20 ml of water as a sample is collected in a conical beaker with a volumetric pipette.
(2) 2 ml of the ammonia buffer solution for hardness measurements is added thereto.
(3) 0.5 ml of indicator Universal BT is added thereto. The solution after the addition is confirmed to be reddish purple.
(4) 0.01 mol/l EDTA·2Na solution is added dropwise from a burette while shaking the conical beaker well, and the point of time when the sample water turned blue is taken as the end point of titration.
(5) The total hardness is determined by the following calculation formula:

$$Hardness ( ° dH ) = T \times 0.01 \times F \times 56.0774 \times 100 / A$$

$$T : titration amount of 0.01 mol / l EDTA \cdot 2 Na solution ( mL )$$

$$A : volume of sample ( 20 mL , volume of sample water )$$

$$F : factor for 0.01 mol / l EDTA \cdot 2 Na solution$$

### [Method for Washing Textile Products]

The present invention provides a method for washing textile products, including washing textile products with a washing liquid containing: (a) an anionic surfactant (hereinafter referred to as component (a)) containing an internal olefin sulfonate with 16 or more and 24 or less carbons (hereinafter referred to as component (a1)); (b1) an amine-based alkali agent (hereinafter referred to as component (b1)); (b2) a carbonate-based alkali agent (hereinafter referred to as component (b2)); and water, wherein the washing liquid has a content of component (a1) in component (a) of 70 mass % or more and 100 mass % or less, and a pH of 7.5 or more and 10.5 or less.

In the method for washing textile products of the present invention, the washing liquid is preferably obtained by mixing the liquid detergent composition of the present invention and water.

The washing liquid can further contain component (c). Further, the washing liquid can further contain component (d). The aspects of component (a), component (a1), component (b1), component (b2), component (c) and component (d) are the same as those described for the liquid detergent composition of the present invention.

The aspect described for the liquid detergent composition of the present invention can be appropriately applied to the method for washing textile products of the present invention.

The hardness of the water to be mixed with the liquid detergent composition of the present invention for the washing liquid is preferably 8° dH or more, more preferably 8.5° dH or more and further preferably 9°dH or more, and preferably 20° dH or less, more preferably 17°dH or less and further preferably 15° dH or less in German hardness from the viewpoints of anti-wrinkle performance for textile products and washing performance to sebum stains.

The hardness of the washing liquid may be in the above range.

In the method for washing textile products of the present invention, the hardness of the washing liquid is a value calculated according to “Method for measuring German hardness of water.” Further, a hardness can be selected for the washing liquid from the preferred range of the hardness of water containing a hardness component as described for the liquid detergent composition of the present invention. The hardness of the washing liquid can also be measured with the measurement method same as that of the above hardness of water. Further, also for water for use in the washing method such as water for use in preparing the washing liquid, water for use in rinsing, or the like, a hardness can be selected from the preferred range of the hardness of water containing a hardness component as described for the liquid detergent composition of the present invention. The hardness of water can also be measured with the measurement method same as that of the above hardness of water.

A content of component (a) in the washing liquid is preferably 50 ppm or more, more preferably 80 ppm or more and further preferably 120 ppm or more, and preferably 1500 ppm or less, more preferably 1200 ppm or less and further preferably 900 ppm or less.

A content of component (a1) in the washing liquid is preferably 50 ppm or more, more preferably 80 ppm or more and further preferably 120 ppm or more, and preferably 1500 ppm or less, more preferably 1200 ppm or less and further preferably 900 ppm or less.

A content of component (b1) in the washing liquid is preferably 3 ppm or more, more preferably 5 ppm or more and further preferably 8 ppm or more, and preferably 84 ppm or less, more preferably 75 ppm or less and further preferably 57 ppm or less.

A content of component (b2) in the washing liquid is preferably 3 ppm or more, more preferably 5 ppm or more and further preferably 11 ppm or more, and preferably 126 ppm or less, more preferably 102 ppm or less and further preferably 75 ppm or less.

A content of component (a1) in component (a), a mass ratio of a content of component (b2) to a total content of component (b1) and component (b2), (b2)/[(b1)+(b2)], a mass ratio of a total content of component (b1) and component (b2) to a content of component (a), [(b1)+(b2)]/(a), and a mass ratio of a total content of component (b1) and component (b2) to a content of component (a1), [(b1)+(b2)]/(a1), in the washing liquid are preferably within the same respective ranges as in the liquid detergent composition of the present invention.

If the washing liquid contains component (c), a content of component (c) in the washing liquid is preferably 0.5 ppm or more, more preferably 1 ppm or more and further preferably 1.5 ppm or more, and preferably 300 ppm or less, more preferably 150 ppm or less and further preferably 30 ppm or less.

The temperature of the washing liquid is preferably 0° C. or more, more preferably 3° C. or more, further preferably 5° C. or more from the viewpoint of capability of achieving more improved washing performance to stains adhering to textile products, and preferably 40° C. or less and more preferably 35° C. or less from the viewpoint of capability of finishing textile products with higher softness and fewer wrinkles without excessively washing off an oil agent contained in the fiber itself constituting a textile product.

The pH of the washing liquid at 20° C. is 7.5 or more, preferably 7.8 or more and more preferably 8.0 or more from the viewpoint of washing performance to sebum stains, and 10.5 or less, preferably 10.0 or less and more preferably 9.5 or less from the viewpoints of preventing fibers from being damaged and thus not inhibiting finishing performance. The pH of the washing liquid can be measured with the same measurement method as the pH of the liquid detergent composition.

The recent upsizing of washing machines has resulted in a tendency of smaller bath ratios, each represented by a ratio of the liquid amount of a washing liquid (L) to the mass of clothing (kg), that is, liquid amount of washing liquid (L)/mass of clothing (kg) (hereinafter this ratio is sometimes referred to as the bath ratio). In using a washing machine for home use, the decrease of the bath ratio may cause larger friction among textile products through stirring in washing to deteriorate the finishing performance for textile products. The method for washing textile products of the present invention allows textile products to be finished with softness and clean appearance even under washing conditions with a small bath ratio. The bath ratio is preferably 2 or more, more preferably 3 or more, further preferably 4 or more and furthermore preferably 5 or more from the viewpoint of finishing textile products with higher softness and cleanliness, and preferably 45 or less, more preferably 40 or less, further preferably 30 or less and furthermore preferably 20 or less from the viewpoint of keeping the detergency.

The washing time in the method for washing textile products of the present invention is preferably 1 minute or more, more preferably 2 minutes or more and further preferably 3 minutes or more from the viewpoints of washing performance to sebum stains and anti-wrinkle performance for fibers, and preferably 1 hour or less, more preferably 30 minutes or less, further preferably 20 minutes or less and furthermore preferably 15 minutes or less from the viewpoint of capability of finishing textile products with higher softness.

The method for washing textile products of the present invention is suitable for a method of soaking fibers in a liquid for use in scouring while the fibers are sent with a roller or the like and for a rotary washing method. The rotary washing method is a washing method in which textile products that are not fixed to a rotating device rotate together with a washing liquid about a rotational axis. The rotary washing method can be carried out with a rotary washing machine. Accordingly, in the present invention, washing of textile products is preferably performed with a rotary washing machine in terms of finishing the textile products with higher cleanliness. Specific examples of the rotary washing machine include, for example, a drum-type washing machine, a pulsator-type washing machine or an agitator-type washing machine. As these rotary washing machines, commercially available ones for home use can be used.

### EXAMPLES

### <Formulation Components>

The following components were used for examples and comparative examples.

[Component (a)]
a-1: a sodium salt of an internal olefin sulfonate with 18 carbons, component (a1)

A mass ratio of olefin species (sodium olefin sulfonate)/hydroxy species (sodium hydroxy alkane sulfonate) in a-1 is 16/84. A mass ratio of a position distribution of a sulfonic acid group in HAS species is as follows:
position 1/position 2/position 3/position 4/position 5/positions 6 to 9=1.5/22.1/17.2/21.8/13.5/23.9 (mass ratio)
Further, (IO-1S)/(IO-2S) is equal to 1.6 by mass ratio.

The position distribution of a sulfonic acid group in HAS species contained in the internal olefin sulfonate of a-1 and the mass ratio of olefin species to hydroxy species (HAS species) were measured with a high-performance liquid chromatography mass spectrometry. Note that an internal olefin sulfonate in which a double bond is present at position 6 or more could not be clearly fractionated due to overlapping peaks. The devices and analysis conditions used for the measurements are the following.

### [Measurement Instrument]

LC device: “LC-20ASXR” (manufactured by Shimadzu Corporation)
LC-MS device: “LCMS-2020” (manufactured by Shimadzu Corporation)
Column: ODS Hypersil (length: 250 mm, inner diameter: 4.6 mm, particle size: 3 μm, manufactured by Thermo Fisher Scientific, Inc.)
Detector: ESI(−), m/z=349.15 (C18), 321.10 (C16), 293.05 (C14)

### [Solvent]

Solvent A: 10 mM ammonium acetate aqueous solution
Solvent B: acetonitrile/water=95/5 solution with 10 mM ammonium acetate added

### [Elution Conditions]

Gradient: solvent A 60%, solvent B 40% (0 to 15 min)→solvent A 30%, solvent B 70% (15.1 to 20 min)→solvent A 60%, solvent B 40% (20.1 to 30 min)
Flow rate: 0.5 ml/min
Column temperature: 40° C.
Injection volume: 5 μl
a-2: sodium lauryl sulfate, “Sodium Dodecyl Sulfate,” manufactured by Tokyo Chemical Industry Co., Ltd.
a-3: sodium polyoxyethylene (2) alkyl ether sulfate, the alkyl group is a mixed alkyl group of a lauryl group and a myristyl group (mass ratio (lauryl group/myristyl group)=72/28), the number in the parentheses is the average number of added moles of oxyethylene groups, “EMAL 270J,” manufactured by Kao Corporation
a-4: sodium alkylbenzene sulfonate “NEOPELEX G-25,” manufactured by Kao Corporation, purity: 25%
   [Component (b1)]
b1-1: monoethanolamine
b1-2: diethanolamine, manufactured by FUJIFILM Wako Pure Chemical Corporation
b1-3: triethanolamine, manufactured by FUJIFILM Wako Pure Chemical Corporation
b1-4: glycine, manufactured by FUJIFILM Wako Pure Chemical Corporation
   [Component (b2)]
b2-1: potassium hydrogen carbonate, manufactured by FUJIFILM Wako Pure Chemical Corporation
b2-2: sodium hydrogen carbonate, manufactured by FUJIFILM Wako Pure Chemical Corporation
b2-3: potassium carbonate, manufactured by FUJIFILM Wako Pure Chemical Corporation
   [Component (c)]
c-1: polypropylene glycol, weight-average molecular weight: 1000, manufactured by AGC Inc.
   [Component (d)]
d-1: fragrance composition

### [Water]

Ion exchange water

### <Preparation of Liquid Detergent Composition>

With the above formulation components, liquid detergent compositions shown in Tables 1 and 2 were prepared through the following method.

A Teflon® stirrer piece with a length of 5 cm was placed in a glass beaker with a capacity of 200 mL, and the mass of them was measured. Next, 20 g of ion exchange water, component (a1), component (a), component (b1), component (b2), component (c) and component (d) were placed therein, potassium hydroxide or hydrochloric acid was added with stirring at 100 r/min so that the pH of the composition reached a value shown in Table 1 or 2, and ion exchange water was added thereto to reach a total amount of 100 g. The resultant was stirred at 100 r/min for 15 minutes to prepare a liquid detergent composition. Note that the values in mass % for the formulation components in Tables 1 and 2 are all numerical values based on effective components.

### <Evaluation of Liquid Color Stability at High Temperature>

After preparation of each of the liquid detergent compositions, 5 g thereof was put in a cuvette, and the liquid color was measured with a colorimeter (manufactured by NIPPON DENSHOKU INDUSTRIES CO., LTD., Z-300A) on the basis of transmitted light at a wavelength of 550 nm, and recorded as a b value. Next, 20 g of each of the liquid detergent compositions after preparation (before storage) was taken and transferred to a No. 6 glass standard bottle, which was placed in a constant temperature bath at 50° C. and stored for 1 week. 5 g of each of the liquid detergent compositions after storage was put in a cuvette, and the b value was recorded in the same manner as before storage, and the difference, Δb, was evaluated as the liquid color stability at high temperature. The results are shown in Tables 1 and 2. Smaller Δb indicates better liquid color stability at high temperature.

### <Evaluation of Low-Temperature Storage Stability>

25 g of each of the liquid detergent compositions after preparation was transferred to a No. 6 glass standard bottle, which was sealed with a cap, placed in a constant temperature bath at 5° C., and left to stand for visual observation, and the time until the occurrence of turbidity was evaluated on the basis of the criteria shown below. The results are shown in Tables 1 and 2.
Rank A: 3 hours or more
Rank B: 1 hour or more and less than 3 hours
Rank C: less than 1 hour

### <Evaluation of Washing Performance to Sebum Stains>

### (1) Preparation of Model Sebum Artificial Stain Cloth

A model sebum artificial stain liquid of the composition shown below was adhered to cloth to prepare model sebum artificial stain cloth. The model sebum artificial stain liquid was printed on the cloth with a gravure roll coater, thereby adhering the artificial stain liquid to the cloth. The step of preparing the model sebum artificial stain cloth by adhering the model sebum artificial stain liquid to the cloth was carried out with a gravure roll cell capacity of 58 cm³/m², a coating rate of 1.0 m/min, a drying temperature of 100° C. and a drying time of 1 minute. Cotton 2003 (manufactured by Tanigashira Shoten) was used as the cloth.
The composition of the model sebum artificial stain liquid was as follows: lauric acid 0.4 mass %, myristic acid 3.1 mass %, pentadecanoic acid 2.3 mass %, palmitic acid 6.2 mass %, heptadecanoic acid 0.4 mass %, stearic acid 1.6 mass %, oleic acid 7.8 mass&, triolein 13.0 mass %, n-hexadecyl palmitate 2.2 mass&, squalene 6.5 mass %, egg white lecithin liquid crystal 1.9 mass %, Kanuma red soil 8.1 mass %, carbon black 0.01 mass %, and the balance of the composition was water (100 mass % in total).

### (2) Measurement of Washing Performance

Four pieces of the above prepared model sebum artificial stain cloth (6 cm×6 cm) were washed with a Terg-O-Tometer (manufactured by Ueshima Seisakusho Co., Ltd., MS-8212) at 60 rpm for 20 minutes. The washing condition was as follows: 1 L of water (the water was ion exchange water, in which the German hardness was adjusted to 14° dH by using calcium chloride and magnesium chloride at a ratio of Ca/Mg=6/4 (mass ratio), and the water temperature was adjusted to 30° C.) was poured so that each of the liquid detergent compositions shown in Table 1 or 2 was 2 g/L, and the washing was carried out with a water temperature at 30° C. After washing, rinsing with municipal water (20° C.) was carried out for 3 minutes. Thereafter, the stain cloth after rinsing was subjected to dehydration treatment for 1 minute with a twin-tub washing machine, and then left to stand for drying under conditions of 20° C. and 43% RH for 12 hours. The washing performance was evaluated on the basis of detergency. Detergency (%) was measured with a method shown below, and the average value for the four pieces was determined. Note that the reflectances at a wavelength of 550 nm of the original cloth before staining and the artificial stain cloth before and after washing were measured with a colorimeter (manufactured by NIPPON DENSHOKU INDUSTRIES CO., LTD., Z-300A).

$$Detergency ( \% ) = 100 \times [ ( reflectance of artificial stain cloth after washing - reflectance of \\ artificial stain cloth before washing ) / ( reflectance of original cloth - reflectance of artificial stain cloth before washing ) ]$$

The detergency-improving rate (%) of the liquid detergent composition of each of examples and comparative examples was calculated from a calculation formula shown below. The results are shown in Tables 1 and 2.

$$Detergency - improving rate ( \% ) = 100 \times [ ( detergency ( \% ) of each example - detergecny ( \% ) of \\ Comparative Example 8 ) / ( detergency ( \% ) of Comparative Example 8 - detergency ( \% ) of Comparative Example 9 ) ]$$

Note that this formula determines the detergency-improving rate (%) of the liquid detergent composition of each of examples and comparative examples with reference to the difference between the detergency of Comparative Example 9 (18.0%) containing component (a1) of the present invention but not containing component (b1) and component (b2) thereof, and the detergency of Comparative Example 8 (24.2%) obtained by adding potassium hydroxide, which is a strong alkali agent, to Comparative Example 9 to adjust the pH to 9.6. Higher detergency-improving rate (%) values indicate better washing performance to sebum stains.

### <Evaluation of Anti-Wrinkle Performance>

### (1) Method for Pretreating Cloth for Use in Evaluation on Wrinkles

1.7 kg of Cotton broad (manufactured by Tanigashira Shoten) was subjected to cumulative washing twice (at the time of washing, 4.7 g of EMULGEN 108 (manufactured by Kao Corporation), water volume: 47 L, washing: 9 minutes, rinsing: twice, dehydration: 3 minutes), followed by cumulative washing of three times with water alone (water volume: 47 L, washing: 9 minutes, rinsing: twice, dehydration: 3 minutes) with an automatic washing machine (manufactured by National, NA-F702P) set to its standard course, and dried under an environment at 23° C. and 45% RH for 24 hours. Thereafter, the resultant was cut to give a textile of 30 cm×60 cm in size, which was then folded by aligning both ends of its short sides, and sewn with a sewing machine. This was used as a 30 cm×30 cm textile for evaluation.

10 T-shirts (manufactured by UNIQLO CO., LTD., 100% cotton) were subjected to cumulative washing twice (at the time of washing, 4.7 g of EMULGEN 108 (manufactured by Kao Corporation), water volume: 47 L, washing: 9 minutes, rinsing: twice, dehydration: 3 minutes), followed by cumulative washing of three times with water alone (water volume: 47 L, washing: 9 minutes, rinsing: twice, dehydration: 3 minutes) with an automatic washing machine (manufactured by National, NA-F702P) set to its standard course, and dried under an environment at 23° C. and 45% RH for 24 hours. The resultants were used as adjuster cloths.

### (2) Method for Evaluating Wrinkles:

To an electric bucket-type washing machine (manufactured by National, model number: “N-BK2”), 4.0 L of hard water (12°dH, prepared by adding only calcium chloride to ion exchange water) was poured. Into the water in the washing machine, 4 g of each of the liquid detergent compositions was put, and the water was stirred for 1 minute. Thereafter, one piece of textile of Cotton broad for evaluation and one adjuster cloth being a T-shirt, which had been pretreated with the above methods, were put therein, and washed for 10 minutes. After washing, the resultants were dehydrated with a twin-tub washing machine (manufactured by Hitachi, Ltd., model number: “PS-H35L”) for 1 minute. Next, 4.0 L of the hard water was poured into the bucket-type washing machine, into which the textile for evaluation and the adjuster cloth after being dehydrated were put, and subjected to rinsing treatment for 3 minutes. Thereafter, the same dehydration treatment was carried out with a twin-tub washing machine for 1 minute. After this rinsing treatment was performed twice in total, the textile of Cotton broad for evaluation was taken out, straightened out, lightly shaken 10 times, and hung and dried under an environment at 25° C. and 45% RH for 24 hours. Six skilled assessors compared each textile for evaluation after being dried in terms of the state of wrinkles with the textile of Comparative Example 8 for evaluation, and performed rating on the basis of the following criteria.
−1 point: worse than Comparative Example 8
0 points: comparable to Comparative Example 8
1 point: slightly better than Comparative Example 8
2 points: better than Comparative Example 8

An average value was calculated from the evaluation values given by the six assessors, and the evaluations were made on the basis of the criteria shown below. The results are shown in Tables 1 and 2.
Rank A: the average value is 0 or more
Rank B: the average value is-0.5 or more and less than 0
Rank C: the average value is less than-0.5

TABLE 1

| | | | | Example | | | | | | | | |
|---|---|---|---|---|---|---|---|---|---|---|---|---|
| | | | | 1 | 2 | 3 | 4 | 5 | 6 | 7 | 8 | 9 |
| Liquid | Formulation | (a) | a-1 | 15 | 15 | 15 | 15 | 11 | 16 | 10.5 | 15 | 15 |
| detergent | composition | | a-2 | | | | | | | 4.5 | | |
| composition | (mass %) | (b1) | b1-1 | 0.5 | 1.2 | 1.9 | 2.5 | 2.8 | 0.8 | 1.2 | 1.2 | 1.2 |
| | | | b1-2 | | | | | | | | | |
| | | | b1-3 | | | | | | | | | |
| | | | b1-4 | | | | | | | | | |
| | | (b2) | b2-1 | 2.5 | 1.8 | 1.1 | 0.5 | 4.2 | 1.2 | 1.8 | 1.8 | 1.8 |
| | | | b2-2 | | | | | | | | | |
| | | | b2-3 | | | | | | | | | |
| | | (c) | c-1 | | | | | 0.2 | 0.2 | | | |
| | | (d) | d-1 | 0.3 | 0.3 | 0.3 | 0.3 | 0.3 | 0.3 | 0.3 | 0.3 | 0.3 |

| | | | | | | | | | |
|---|---|---|---|---|---|---|---|---|---|
| Water | balance | balance | balance | balance | balance | balance | balance | balance | balance |
| Total | 100 | 100 | 100 | 100 | 100 | 100 | 100 | 100 | 100 |

| | | | | | | | | | | |
|---|---|---|---|---|---|---|---|---|---|---|
| | pH (20° C.) | 9.6 | 9.6 | 9.6 | 9.6 | 9.6 | 9.6 | 9.6 | 8.5 | 9 |
| | (b2)/[(b1) + (b2)] (mass ratio) | 0.83 | 0.60 | 0.37 | 0.17 | 0.60 | 0.60 | 0.60 | 0.60 | 0.60 |
| | [(b1) + (b2)]/(a) (mass ratio) | 0.20 | 0.20 | 0.20 | 0.20 | 0.64 | 0.13 | 0.20 | 0.20 | 0.20 |
| | (a1)/(a) (mass %) | 100 | 100 | 100 | 100 | 100 | 100 | 70 | 100 | 100 |
| Evaluation | Liquid color stability at high | 0.37 | 0.45 | 1.33 | 1.91 | 2.30 | 0.80 | 0.36 | 0.36 | 0.40 |
| | temperature (Δb) | | | | | | | | | |
| | Low-temperature (5° C.) | A | A | A | A | B | A | A | A | A |
| | storage stability | | | | | | | | | |
| | Detergency-improving rate | 46.8 | 55.1 | 59.3 | 50.1 | 78.0 | 48.5 | 78.2 | 55.6 | 59.5 |
| | (%) | | | | | | | | | |
| | Anti-wrinkle performance | A | A | A | A | B | A | B | A | A |

| | | | | Example | | | | | | | |
|---|---|---|---|---|---|---|---|---|---|---|---|
| | | | | 10 | 11 | 12 | 13 | 14 | 15 | 16 | 17 |
| Liquid | Formulation | (a) | a-1 | 15 | 15 | 15 | 15 | 15 | 15 | 15 | 15 |
| detergent | composition | | a-2 | | | | | | | | |
| composition | (mass %) | (b1) | b1-1 | 1.2 | | | | 1.2 | 1.2 | 0.2 | 2.8 |
| | | | b1-2 | | 1.2 | | | | | | |
| | | | b1-3 | | | 1.2 | | | | | |
| | | | b1-4 | | | | 1.2 | | | | |
| | | (b2) | b2-1 | 1.8 | 1.8 | 1.8 | 1.8 | | | 2.8 | 0.2 |
| | | | b2-2 | | | | | 1.8 | | | |
| | | | b2-3 | | | | | | 1.8 | | |
| | | (c) | c-1 | | | | | | | | |
| | | (d) | d-1 | 0.3 | 0.3 | 0.3 | 0.3 | 0.3 | 0.3 | 0.3 | 0.3 |

| | | | | | | | | |
|---|---|---|---|---|---|---|---|---|
| Water | balance | balance | balance | balance | balance | balance | balance | balance |
| Total | 100 | 100 | 100 | 100 | 100 | 100 | 100 | 100 |

| | | | | | | | | | |
|---|---|---|---|---|---|---|---|---|---|
| | pH (20° C.) | 11 | 9.6 | 9.6 | 9.6 | 9.6 | 9.6 | 9.6 | 9.6 |
| | (b2)/[(b1) + (b2)] (mass ratio) | 0.60 | 0.60 | 0.60 | 0.60 | 0.60 | 0.60 | 0.93 | 0.07 |
| | [(b1) + (b2)]/(a) (mass ratio) | 0.20 | 0.20 | 0.20 | 0.20 | 0.20 | 0.20 | 0.20 | 0.20 |
| | (a1)/(a) (mass %) | 100 | 100 | 100 | 100 | 100 | 100 | 100 | 100 |
| Evaluation | Liquid color stability at high | 0.60 | 0.38 | 0.19 | 0.30 | 0.89 | 1.03 | 0.15 | 2.42 |
| | temperature (Δb) | | | | | | | | |
| | Low-temperature (5° C.) | A | A | A | A | A | A | A | A |
| | storage stability | | | | | | | | |
| | Detergency-improving rate | 56.2 | 51.7 | 46.7 | 57.8 | 53.3 | 48.1 | 38.9 | 43.5 |
| | (%) | | | | | | | | |
| | Anti-wrinkle performance | A | A | A | A | A | A | A | A |

TABLE 2

| | | | | Comparative Example | | | | | | |
|---|---|---|---|---|---|---|---|---|---|---|
| | | | | 1 | 2 | 3 | 4 | 5 | 6 | 7 |
| Liquid | Formulation | (a) | a-1 | 15 | 15 | 15 | 15 | 15 | 15 | 15 |
| detergent | composition | | a-2 | | | | | | | |
| composition | (mass %) | | a-3 | | | | | | | |
| | | | a-4 | | | | | | | |
| | | (b1) | b1-1 | 1 | 2 | 3 | 4 | | | |
| | | (b2) | b2-1 | | | | | 3 | 4 | 4 |
| | | (c) | c-1 | | | | | | | 0.2 |
| | | (d) | d-1 | 0.3 | 0.3 | 0.3 | 0.3 | 0.3 | 0.3 | 0.3 |

| | | | | | | | |
|---|---|---|---|---|---|---|---|
| Water | balance | balance | balance | balance | balance | balance | balance |
| Total | 100 | 100 | 100 | 100 | 100 | 100 | 100 |

| | | | | | | | | |
|---|---|---|---|---|---|---|---|---|
| | pH (20° C.) | 9.6 | 9.6 | 9.6 | 9.6 | 9.6 | 9.6 | 9.6 |
| | (b2)/[(b1) + (b2)] (mass ratio) | 0 | 0 | 0 | 0 | 1 | 1 | 1 |
| | [(b1) + (b2)]/(a) (mass ratio) | 0.07 | 0.13 | 0.20 | 0.27 | 0.20 | 0.27 | 0.27 |
| | (a1)/(a) (mass %) | 100 | 100 | 100 | 100 | 100 | 100 | 100 |
| Evaluation | Liquid color stability at high | 2.15 | 2.54 | 2.84 | 3.89 | 0.14 | 0.17 | 0.17 |
| | temperature (Δb) | | | | | | | |
| | Low-temperature (5° C.) storage | A | A | A | A | A | B | B |
| | stability | | | | | | | |
| | Detergency-improving rate (%) | 0.3 | 33.6 | 42.2 | 69.3 | 14.5 | 36.5 | 40.1 |
| | Anti-wrinkle performance | A | A | A | A | A | A | A |

| | | | | Comparative Example | | | | | |
|---|---|---|---|---|---|---|---|---|---|
| | | | | 8 | 9 | 10 | 11 | 12 | 13 |
| Liquid | Formulation | (a) | a-1 | 15 | 15 | | | | 7.5 |
| detergent | composition | | a-2 | | | 15 | | | 7.5 |
| composition | (mass %) | | a-3 | | | | | 15 | |
| | | | a-4 | | | | 15 | | |
| | | (b1) | b1-1 | | | 1.2 | 1.2 | 1.2 | 1.2 |
| | | (b2) | b2-1 | | | 1.8 | 1.8 | 1.8 | 1.8 |
| | | (c) | c-1 | | | | | | |
| | | (d) | d-1 | 0.3 | 0.3 | 0.3 | 0.3 | 0.3 | 0.3 |

| | | | | | | |
|---|---|---|---|---|---|---|
| Water | balance | balance | balance | balance | balance | balance |
| Total | 100 | 100 | 100 | 100 | 100 | 100 |

| | | | | | | | |
|---|---|---|---|---|---|---|---|
| | pH (20° C.) | 9.6 | 7.5 | 9.6 | 9.6 | 9.6 | 9.6 |
| | (b2)/[(b1) + (b2)] (mass ratio) | — | — | 0.60 | 0.60 | 0.60 | 0.60 |
| | [(b1) + (b2)]/(a) (mass ratio) | 0 | 0 | 0.20 | 0.20 | 0.20 | 0.20 |
| | (a1)/(a) (mass %) | 100 | 100 | 0 | 0 | 0 | 50 |
| Evaluation | Liquid color stability at high | 0.12 | 0.11 | 0.20 | 0.25 | 0.21 | 0.33 |
| | temperature (Δb) | | | | | | |
| | Low-temperature (5° C.) storage | A | A | C | A | A | A |
| | stability | | | | | | |
| | Detergency-improving rate (%) | reference | reference | 15.5 | −49.6 | 190 | 62.4 |
| | Anti-wrinkle performance | reference | A | C | B | C | C |

1: A liquid detergent composition, comprising:
component (a); an anionic surfactant containing an internal olefin sulfonate with 16 or more and 24 or less carbons as component (a1);
component (b1) an amine-based alkali agent;
component (b2) a carbonate-based alkali agent; and
water,
wherein the liquid detergent composition has a content of the component (a1) in the component (a) of 70 mass % or more and 100 mass % or less, and a pH of 8.5 or more and 11.0 or less at 20° C.

2: The liquid detergent composition according to claim 1, wherein (b2)/(b1)+(b2), which is a mass ratio of a content of the component (b2) to a total content of the component (b1) and the component (b2), in the liquid detergent composition, is 0.1 or more and 0.83 or less.

3: The liquid detergent composition according to claim 1, wherein [(b1)+(b2)]/(a), which is a mass ratio of a total content of the component (b1) and the component (b2) to a content of the component (a) in the liquid detergent composition, is 0.13 or more and 0.65 or less.

4: The liquid detergent composition according to claim 1, wherein
the component (a1) comprises (IO-1S), which is an internal olefin sulfonate with a sulfonic acid group present at position 2 or more and 4 or less; and (IO-2S), which is an internal olefin sulfonate with a sulfonic acid group present at position 5 or more, and
(IO-1S)/(IO-2S), which is a mass ratio of a content of (IO-1S) to a content of (IO-2S), is 0.5 or more and 10 or less.

5: The liquid detergent composition according to claim 1, wherein the component (b1) is one or more selected from the group consisting of an alkanolamine and an amino acid.

6: The liquid detergent composition according to claim 1, wherein the component (b1) is one or more selected from the group consisting of monoethanolamine, diethanolamine, triethanolamine, and glycine.

7: The liquid detergent composition according to claim 1, wherein the component (b2) is one or more selected from the group consisting of sodium carbonate, potassium carbonate, sodium sesquicarbonate, potassium sesquicarbonate, sodium hydrogen carbonate, and potassium hydrogen carbonate.

8: The liquid detergent composition according to claim 1, wherein the composition is for use in washing textile products.

9: The liquid detergent composition according to claim 8, wherein the composition is for use in washing textile products in water having a hardness of 8°dH or more and 20° dH or less.

10: A method for washing textile products, the method comprising: washing textile products with a washing liquid comprising:
a liquid detergent composition containing (a) an anionic surfactant as component (a) containing an internal olefin sulfonate with 16 or more and 24 or less carbons as component (a1); (b1) an amine-based alkali agent as component (b1); and (b2) a carbonate-based alkali agent as component (b2); and
water,
wherein the washing liquid has a content of the component (a1) in the component (a) of 70 mass % or more and 100 mass % or less, and a pH of 7.5 or more and 10.5 or less.

11: The method according to claim 10, wherein (b2)/[(b1)+(b2)], which is a mass ratio of a content of the component (b2) to a total content of the component (b1) and the component (b2) in the washing liquid, is 0.1 or more and 0.83 or less.

12: The method according to claim 10, wherein (b1)+(b2)/(a), which is a mass ratio of a total content of the component (b1) and the component (b2) to a content of the component (a), in the washing liquid, is 0.13 or more and 0.65 or less.

13: The method according to claim 10, wherein the liquid detergent composition has a pH of 8.5 or more and 11.0 or less at 20° C.

14: The method according to claim 10, wherein the washing liquid has a hardness of 8°dH or more and 20° dH or less.

15: The liquid detergent composition according to claim 1, wherein (b2)/[(b1)+(b2)], which is a mass ratio of a content of the component (b2) to a total content of the component (b1) and the component (b2) in the liquid detergent composition, is 0.1 or more and 0.83 or less, and
[(b1)+(b2)]/(a), which is a mass ratio of a total content of the component (b1) and the component (b2) to a content of the component (a) in the liquid detergent composition, is 0.13 or more and 0.5 or less, and
the liquid detergent composition has a content of the component (a1) in the component (a) of 80 mass % or more and 100 mass % or less.

16: The liquid detergent composition according to claim 1, wherein (b2)/[(b1)+(b2)], which is a mass ratio of a content of the component (b2) to a total content of the component (b1) and the component (b2), in the liquid detergent composition, is 0.4 or more and 0.65 or less, and
[((b1)+(b2)]/(a), which is a mass ratio of a total content of the component (b1) and the component (b2) to a content of the component (a) in the liquid detergent composition, is 0.13 or more and 0.5 or less, and
the liquid detergent composition has a content of the component (a1) in the component (a) of 80 mass % or more and 100 mass % or less.
